(19) United States
(12) Patent Application Publication
(10) Pub. No.: US 2023/0354729 A1
(43) Pub. Date: Nov. 9, 2023

(54) STRIP FRESHENER ASSEMBLY

(71) Applicant: Don Sandell, Fort Dodge, IA (US)

(72) Inventors: Don Sandell, Fort Dodge, IA (US); Kyle Allen Post, Titonka, IA (US)

(21) Appl. No.: 18/313,194

(22) Filed: May 5, 2023

Related U.S. Application Data
(60) Provisional application No. 63/482,624, filed on Feb. 1, 2023.
(60) Provisional application No. 63/338,683, filed on May 5, 2022.

(51) Int. Cl. A01B 35/28

(52) U.S. Cl. CPC A01B 35/28

(57) ABSTRACT

A strip freshener is disclosed that includes a tine having a retention portion and a tooth. The tine is received in a cavity in a mounting member, and the retention portion of the tine is retained by a retaining member that is removably connected to the mounting member. A sleeve is fixedly connected to the mounting member and is connected to a frame. The frame has a spindle assembly that is configured to rotate the sleeve. The frame also has a toe angle assembly and a camber assembly that are configured to adjust the toe angle and camber of the sleeve, respectively, in relation to the frame. The strip freshener can be used to prepare a narrow strip of soil for planting by breaking up the soil, mixing it with air, and adding fertilizer.

### CROSS REFERENCE TO RELATED APPLICATION

This application claims the benefit U.S. Provisional Pat. Application Serial No. 63/338,683 filed May 5, 2023, and U.S. Provisional Pat. Application Serial No. 63/482,624 filed Feb. 1, 2023, the contents of these applications are hereby incorporated by reference in their entirety.

### BACKGROUND

This disclosure generally relates to a strip freshener. More specifically, the disclosure relates to a strip freshener having replaceable teeth and adjustable frame.

Strip fresheners are known in the art given the prevalence of strip tilling. Strip tilling is a sustainable farming system that tills a portion of, rather than all, the available arable land to limit the disturbance to the soil. The goal of strip tilling is to improve soil health by retaining the amount of organic matter in the soil and reducing disturbance. Another advantage of strip tilling comes from the potential fuel costs from less tilling taking place. In contrast to a no-till methodology, strip tilling is commonly viewed as providing a superior seed bed while achieving the benefits of tilling only a portion of the farmland.

A strip freshener prepares the narrow strip of soil that is used for planting. The strip freshener breaks up the solid soil with a blade or disc, mixing it with air, and commonly adding fertilizer or other composition to improve plant growth. The tilled soil has improved drainage and aeration compared to untilled land, which improves germination, growth, and overall crop yield.

It is advantageous during the strip till to control the breakup of the soil in order to provide a strip with minimum clods and voids, and a consistently developed berm. Conventional strip fresheners suffer from a number of deficiencies in this area. For example, some strip fresheners are configured with a front row of freshener gangs that are angled in one direction followed by a second row of freshener gangs that are angled in the opposite direction. This arrangement fails to form a proper berm for planting. More generally, conventional strip fresheners fail to control the discharge of soil during a till. It is advantageous in most instances to operate the strip till with a closing system that forms a berm of friable soil. When the discharge is uncontrollable, performing such an operation is difficult, if not impossible in some instances.

Given the unique nature of soil composition from area to area, it is detrimental to have a strip freshener that cannot accommodate different soil conditions. For example, it may be desirable to perform a shallower till to avoid disturbing an underlying seed bed that has been established over years of cultivation. Conventional strip fresheners cannot readily accommodate these nuances leading to the destruction of quality seed beds.

Another disadvantage is maintenance of strip fresheners. Conventional strip fresheners use discs or blades that are monolithically constructed, such as formed through casting. As a result, conventional discs and blades are brittle and prone to breakage, especially when untillable materials such as rocks are struck by the blade or discs. The absence of a relief system leads to downtime, which is to be avoided as much as possible.

When a repair or replacement is needed, the process is inhibited by conventional strip fresheners. This is due to the shaft about which the discs or blades rotates having a bearing on an interior end. Similarly, the presence of this bearing makes it impossible to arrange the blades or discs close enough together to form a desirable berm.

Thus it is a primary aspect of this disclosure to provide a strip freshener that improves upon the art.

Another aspect of this disclosure is to provide a strip freshener that improves strip tilling.

Yet another aspect of this disclosure is to provide a strip freshener that limits the occurrence of clods and voids in a reformed berm.

Another aspect of this disclosure is to provide a strip freshener that forms a berm of friable soil.

Yet another aspect of this disclosure is to provide a strip freshener that is adjustable with respect to till depth and strip closing.

Another aspect of this disclosure is to provide a strip freshener that avoids component breakage.

Yet another aspect of this disclosure is to provide a strip freshener that is easily repairable and/or replaceable.

Another aspect of this disclosure is to provide a strip freshener that decreases downtime.

Yet another aspect of this disclosure is to provide a strip freshener that is cost-effective.

Another aspect of this disclosure is to provide a strip freshener that is user friendly.

These and other aspects, features, and advantages of the invention will become apparent from the specification and claims.

### SUMMARY OF THE INVENTION

The disclosure provides various aspects of a strip freshener.

In some aspects, the techniques broadly described herein relate to a strip freshener including: a tine having a retention portion and a tooth; a mounting member having a cavity in a first surface of the mounting member; the retention portion of the tine received in the cavity; a retaining member removably connected to the mounting member; and wherein the cavity is shaped like the retention portion; wherein the retention portion is positioned between the retaining member and a second surface of the mounting member.

In some aspects, the techniques broadly described herein relate to a strip freshener wherein the retention portion has a circular base and a rectangular portion, and the rectangular portion is positioned between the circular base and the tooth.

In some aspects, the techniques broadly described herein relate to a strip freshener wherein the retention portion is flush with the first surface of the mounting member such that the retaining member engages the retention portion.

In some aspects, the techniques broadly described herein relate to a strip freshener wherein the tooth tapers from the retention portion in a helix shape.

In some aspects, the techniques broadly described herein relate to a strip freshener further including a sleeve that extends from a first end to a second end, and the mounting member is fixedly connected to the sleeve.

In some aspects, the techniques broadly described herein relate to a strip freshener further including a second tine received in a second mounting member; a second retaining member removably connected to the second mounting member; wherein the second mounting member is smaller than the mounting member.

In some aspects, the techniques broadly described herein relate to a strip freshener further including the second mounting member having a second cavity, wherein the second cavity is sized and shaped to match the cavity of the mounting member.

In some aspects, the techniques broadly described herein relate to a strip freshener further including a sleeve that extends from a first end and a second end; the mounting member and the second mounting member arranged in a back-to-back arrangement such that the retaining member and the second retaining member are positioned outwards towards the first end and the second end of the sleeve.

In some aspects, the techniques broadly described herein relate to a strip freshener further including a spindle assembly having a shaft that extends from a first end to a second end, a frame connector, a cap, and a bearing; the bearing contained inside the cap and around the shaft; the cap connected to the first end of the shaft; the shaft received within and connected to the sleeve; and the frame connector connected to a frame; wherein no other bearing is positioned outside of the cap.

In some aspects, the techniques broadly described herein relate to a strip freshener wherein the second end of the shaft extends to the second end of the sleeve.

In some aspects, the techniques broadly described herein relate to a strip freshener further including the sleeve connected to a bracket of a toe angle assembly; the toe angle assembly having a toe plate pivotally connected to a bracket plate of the bracket; wherein the toe angle assembly is configured to adjust a toe angle of the tine and the mounting member in relation to the toe plate.

In some aspects, the techniques broadly described herein relate to a strip freshener further including the toe plate having a swivel slot that aligns with a swivel bore of the bracket plate.

In some aspects, the techniques broadly described herein relate to a strip freshener further including the toe plate having a toe window configured to show a position of the bracket plate relative to the toe plate; and an indicia set next to the toe window; wherein the indicia represents at least one predefined toe angle when the bracket plate aligns with the indicia.

In some aspects, the techniques broadly described herein relate to a strip freshener further including the sleeve pivotally connected to a camber plate of a camber assembly; wherein the camber assembly is configured to adjust a camber of the tine and the mounting member.

In some aspects, the techniques broadly described herein relate to a strip freshener further including the camber assembly including a vertical plate connected to a toe plate; the toe plate connected to the sleeve; and the vertical plate pivotally connected to the camber plate by a camber rod assembly received through a camber bore.

In some aspects, the techniques broadly described herein relate to a strip freshener further including the vertical plate and the camber plate having an offset bore; an offset connector received through the offset bore.

In some aspects, the techniques broadly described herein relate to a strip freshener further including the camber rod assembly having a camber rod and a rod pin; wherein the rod pin fixes the camber.

In some aspects, the techniques broadly described herein relate to a strip freshener wherein the rod pin is configured to shear.

In some aspects, the techniques broadly described herein relate to a strip freshener further including the sleeve connected to a stem assembly having a stem; and the sleeve connected to a scraper configured to remove debris from the tine.

In some aspects, the techniques broadly described herein relate to a strip freshener including: a tine having a retention portion and a tooth; a mounting member having a cavity in a first surface of the mounting member, wherein the cavity is shaped like the retention portion; the retention portion of the tine received in the cavity; a retaining member removably connected to the mounting member, wherein the retention portion is positioned between the retaining member and a second surface of the mounting member; a sleeve fixedly connected to the mounting member; the sleeve connected to a frame; the frame having a spindle assembly; wherein the spindle assembly is configured to rotate the sleeve; the frame having a toe angle assembly, wherein the toe angle assembly is configured to adjust a toe angle of the sleeve relative to the frame; and the frame having a camber assembly, wherein the camber assembly is configured to adjust a camber of the sleeve relative to the frame.

This has outlined, rather broadly, the features, advantages, solutions, and benefits of the disclosure in order that the description that follows may be better understood. Additional features, advantages, solutions, and benefits of the disclosure will be described in the following. It should be appreciated by those skilled in the art that this disclosure may be readily utilized as a basis for modifying or designing other structures and related operations for carrying out the same purposes of the present disclosure. It should also be realized by those skilled in the art that such equivalent constructions and related operation do not depart from the teachings of the disclosure as set forth in the appended claims. The novel features, together with further objects and advantages, will be better understood from the following description when considered in connection with the accompanying Figures. It is to be expressly understood, however, that each of the Figures is provided for the purpose of illustration and description only and is not intended as a definition of the limits of the present disclosure.

### BRIEF DESCRIPTION OF THE DRAWINGS

FIG. 1 is a rear, perspective view of a strip freshener according to an aspect of the disclosure;

FIG. 2 is a rear view of a strip freshener according to an aspect of the disclosure;

FIG. 3 is a front view of a strip freshener according to an aspect of the disclosure;

FIG. 4 is a side view of a strip freshener according to an aspect of the disclosure;

FIG. 5 is a rear view of a strip freshener according to an aspect of the disclosure;

FIG. 6 is an exploded, perspective view of a strip freshener according to an aspect of the disclosure;

FIG. 7 is a top, perspective view of a strip freshener according to an aspect of the disclosure;

FIG. 8 is a top, perspective view of a strip freshener according to an aspect of the disclosure;

FIG. 9 is a rear view of a strip freshener according to an aspect of the disclosure;

FIG. 10 is a perspective view of a strip freshener according to an aspect of the disclosure;

FIG. 11 is a side view of a strip freshener according to an aspect of the disclosure;

FIG. 12 is a side view of a strip freshener according to an aspect of the disclosure;

FIG. 13 is a side view of a strip freshener according to an aspect of the disclosure;

FIG. 14 is a partial exploded, perspective view of a strip freshener according to an aspect of the disclosure;

FIG. 15 is a perspective view of a strip freshener according to an aspect of the disclosure;

FIG. 16 is a side, perspective view of a strip freshener according to an aspect of the disclosure; and

FIG. 17 is a perspective view of a strip freshener according to an aspect of the disclosure.

### DETAILED DESCRIPTION

The disclosure described herein is directed to different aspects of a strip freshener 10. The detailed description set forth below, in connection with the appended drawings, is intended as a description of various configurations and is not intended to represent the only configurations in which the concepts described herein may be practiced. These descriptions include specific details for the purpose of providing a thorough understanding of the various concepts. It will be apparent, however, to those skilled in the art that these concepts may be practiced without these specific details. In some instances, well-known structures and components are shown in block diagram form in order to avoid obscuring such concepts. As described herein, the use of the term “and/or” is intended to represent an “inclusive OR”, and the use of the term “or” is intended to represent an “exclusive OR”.

The disclosure is described herein with reference to certain aspects, iterations, embodiments, and examples but it is understood that the disclosure can be embodied in many different forms and should not be construed as limited to the aspects set forth herein. In particular, the disclosure is described herein in regard to a strip freshener with one or two freshener gangs having one or two hubs on a freshener gang, but it is understood that the disclosure can include any number of freshener gangs having any number of hubs.

The disclosure is described herein with reference to certain aspects, iterations, embodiments, and examples but it is understood that the disclosure can be embodied in many different forms and should not be construed as limited to the aspects set forth herein.

Although the terms first, second, etc. may be used herein to describe various elements or components, these elements or components should not be limited by these terms. These terms are only used to distinguish one element or component from another. Hence, a first element discussed herein could be termed a second element without departing from the teachings of the present application. It is understood that actual systems or fixtures embodying the disclosure can be arranged in many different ways with many more features and elements beyond what is shown in the drawings. For the same or similar elements or features, the same reference numbers may be used throughout the disclosure.

It is to be understood that when an element or component is referred to as being “on” another element or component, it can be directly on the other element or intervening elements may also be present. Furthermore, relative terms such as “between”, “within”, “below”, and similar terms, may be used herein to describe a relationship of one element or component to another. It is understood that these terms are intended to encompass different orientations of the disclosure in addition to the orientation depicted in the figures.

With reference to the Figures aspects of a strip freshener 10 are shown according to the disclosure. The strip freshener 10 comprises a freshener gang 12 configured to connect to a frame 14. In other aspects, the frame 14 comprises one or more of a spindle assembly 16 configured to rotate the freshener gang 12, a swivel or toe angle assembly 18 configured to adjust the toe angle of the freshener gang 12, a pivot or camber assembly 20 configured to adjust the camber of the freshener gang 12, a scraper 22 configured to remove built up soil and material from the freshener gang 12, and/or a stem assembly 24 configured to attached the strip freshener 10 to a tool bar 26 (not shown) of a tractor 28 (not shown).

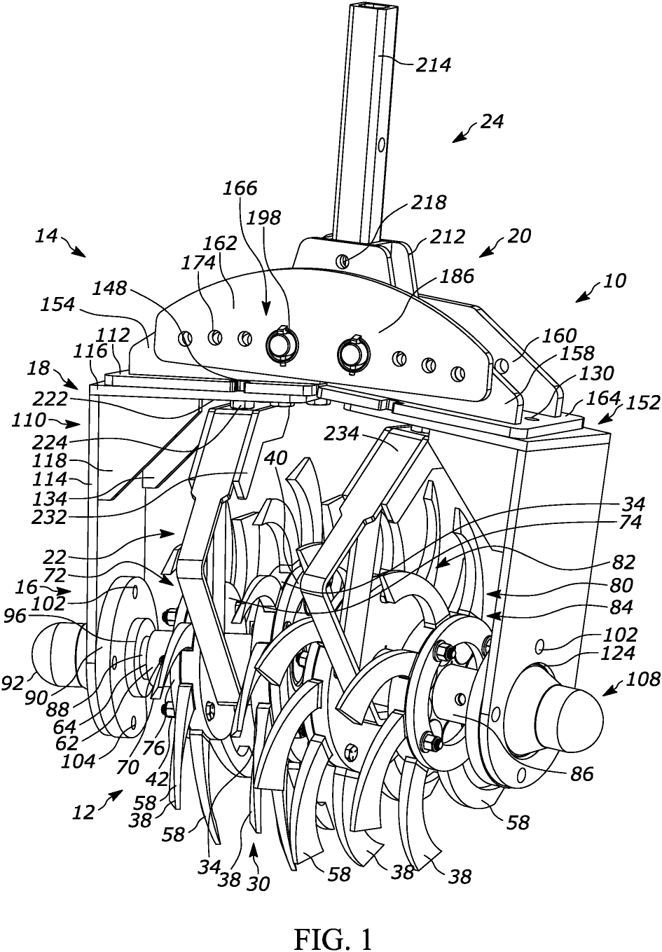

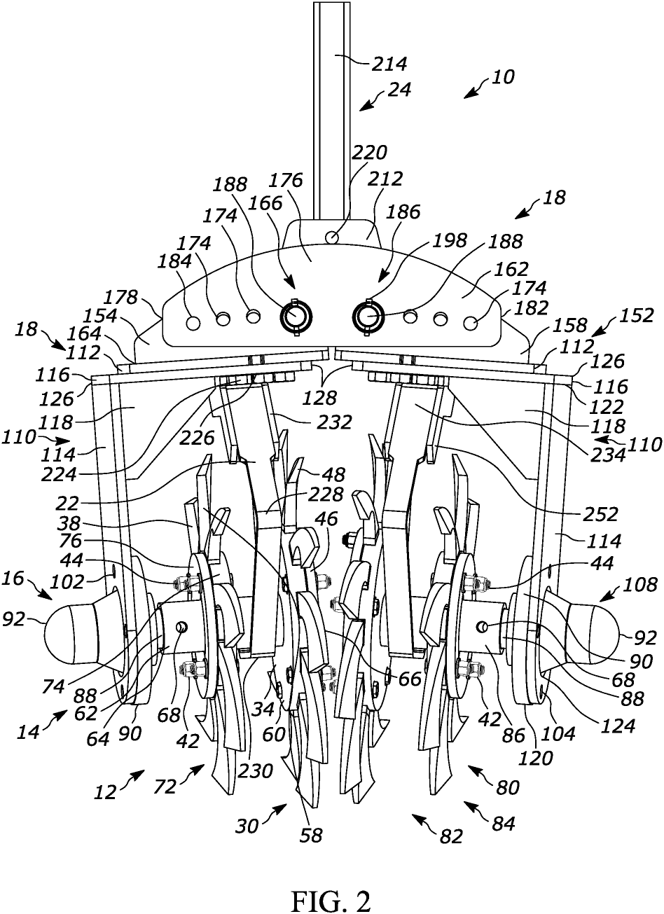

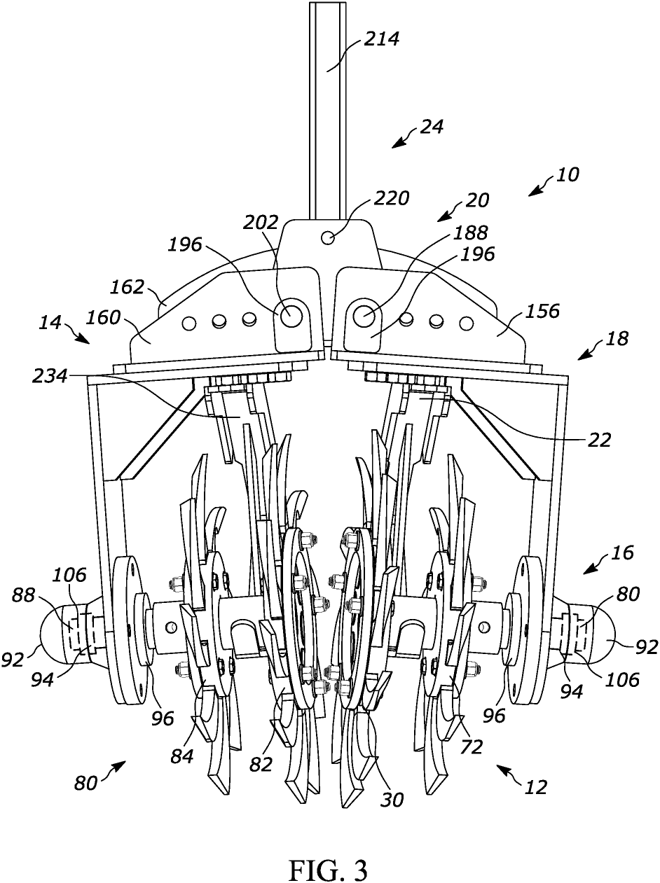

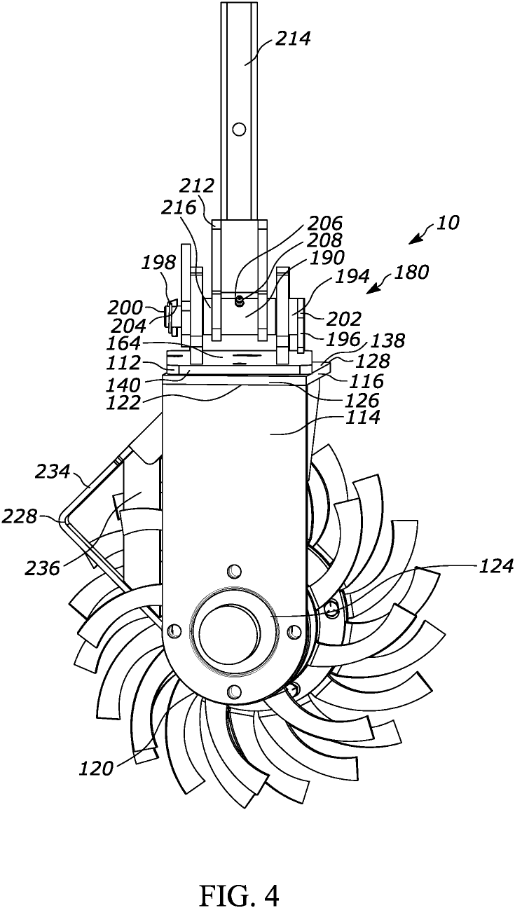

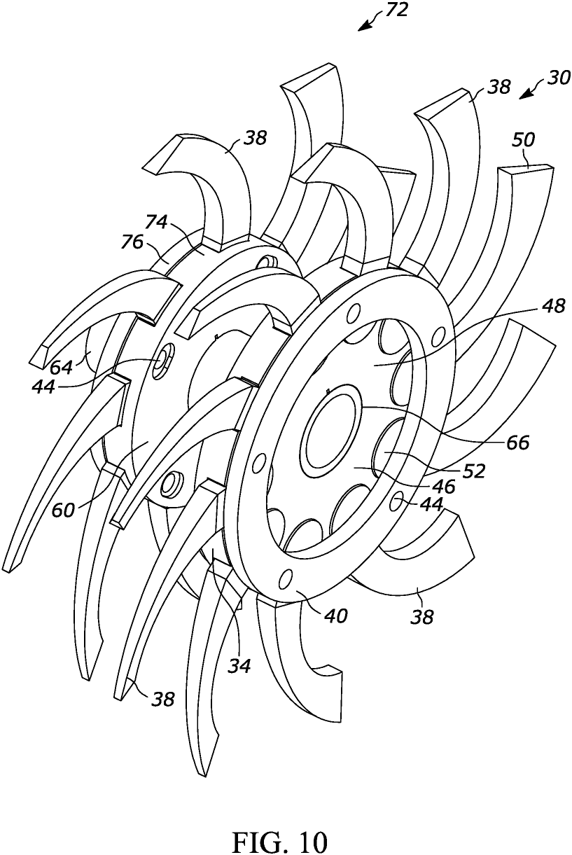

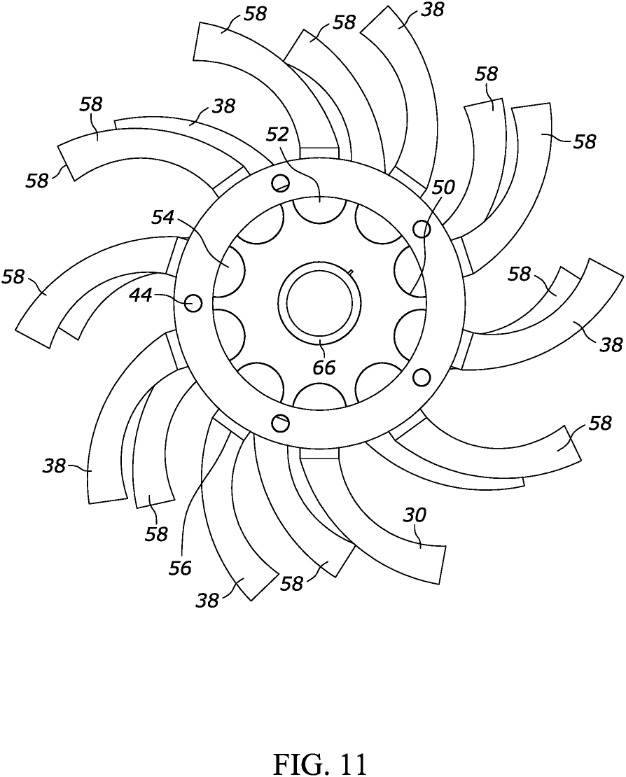

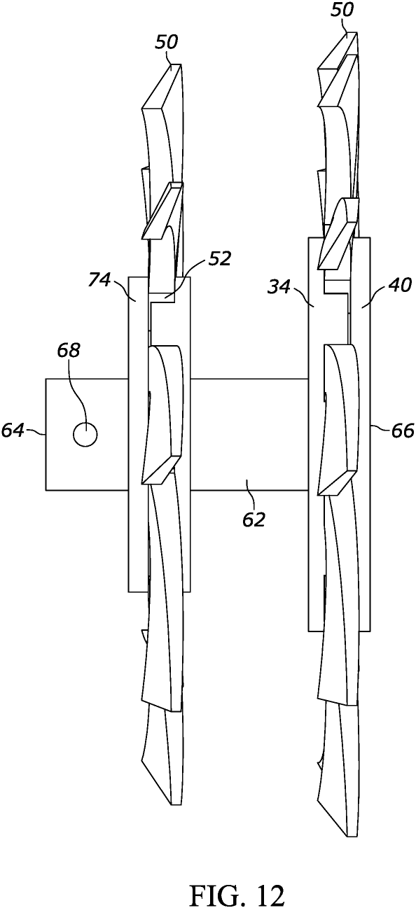

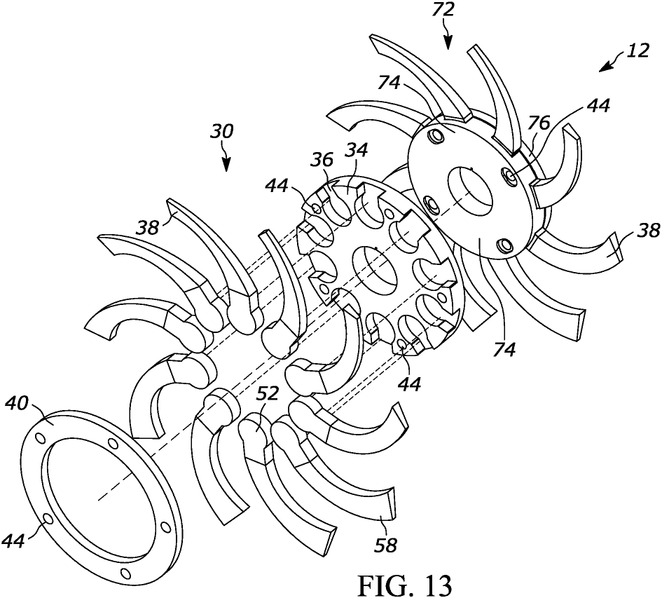

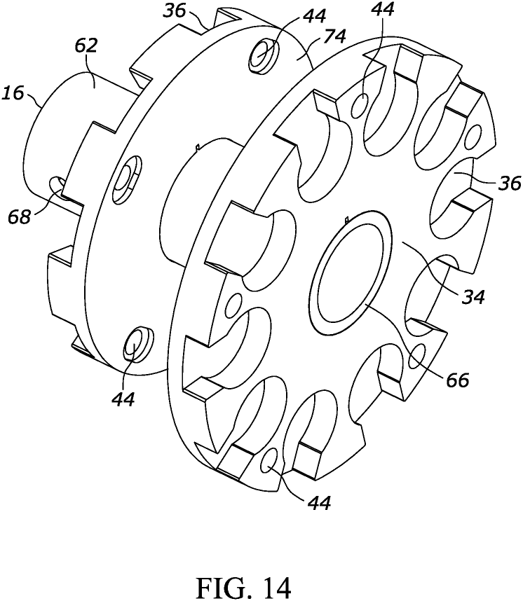

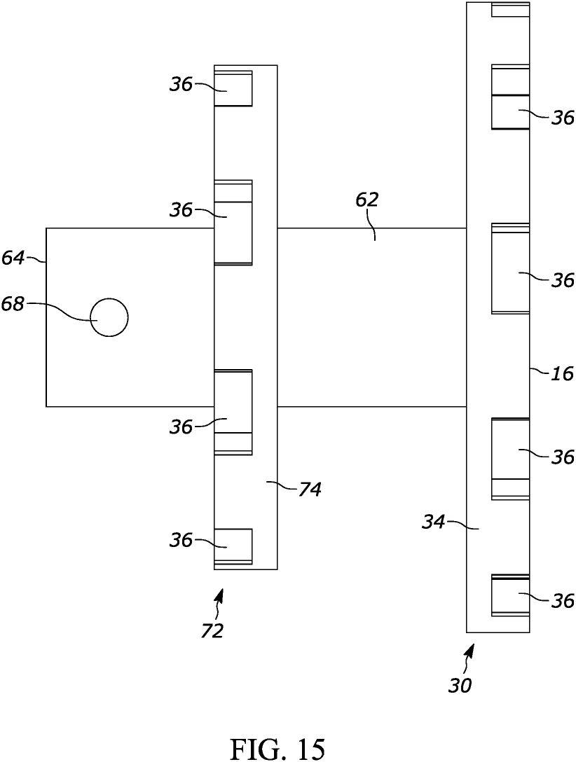

In some aspects, and as depicted in at least FIGS. 1-4, 10-15, and 17, the freshener gang 12 comprises a first hub 30 comprising one or more of a first mounting member or ring 34 with a cavity 36 that a tine 38 is received within. In other aspects, a first retaining member or ring 40 connects to the first mounting ring 34 via a hub connector 42 received through a hub bore 44 to retain a tine 38 between the first mounting ring 34 and the first retaining ring 40. In still other aspects, the first hub 30 has a disc shape with the tine 38 extending therefrom.

In further aspects, the first mounting ring 34 has a plurality of cavities 36 positioned around a perimeter or circumference of the first mounting ring 34 on a first surface 46, which in still further aspects are evenly spaced about the entire perimeter of the first mounting ring 34. The cavity 36, in some aspects, is recessed within the first mounting ring 34 and sized and shaped to conform to a shape of the tine 38 as described in other aspects disclosed herein.

In other aspects, the tine 38 extends between a first end 48 to a second end 50. Extending from the first end 48 towards the second end is a retention portion or bulb 52 that is sized and shaped to conform to the size and shape of the cavity 36. In certain aspects, the bulb 52 has a circular base 54 that extends into a rectangular portion 56. In still other aspects, the tine 38 has a tooth 58 that extends from the bulb 52 to the second end 50 of the tine 38. Such a configuration of the bulb 52 facilitates replacement of the tine 38 and improves the durability of the bulb 52 compared to other configurations, such as a T-shaped configuration that is rigid and prone to breakage.

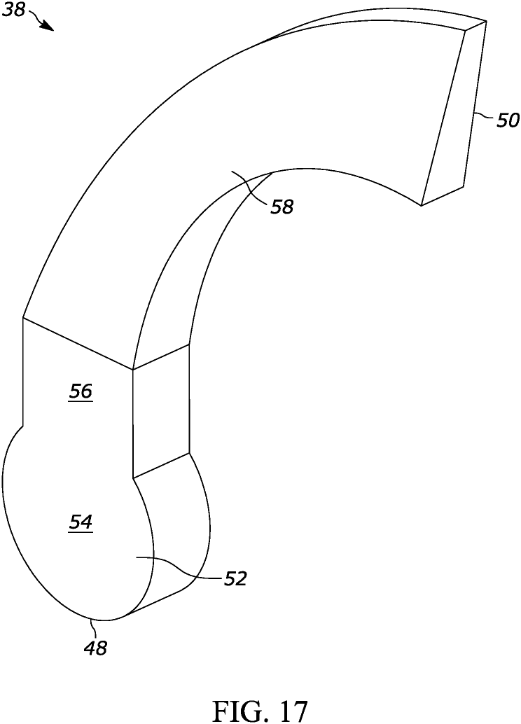

In yet further aspects, the tooth 58 tapers from the bulb 52 to the second end 50 and in particular aspects, the tooth 58 tapers in a helix shape such as the exemplary illustration shown in FIG. 17. In such a configuration, the tapered leading edge of the tooth 58 provides a cutting surface during tilling while the wider following edge provides strength and durability to the tooth 58. In further aspects, a plurality of the tine 38 are received in each of the plurality of the cavity 36 positioned about the first mounting ring 34. In still further aspects, a second surface 60 opposite of the first surface 46 of the first mounting ring 34 is flat and uniform.

In some aspects, the first retaining ring 40 is sized and shaped to have a perimeter or circumference that matches the first mounting ring 34. In other aspects, the hub bore 44 extends through the first retaining ring 40 and both the first surface 46 and the second surface 60 of the first mounting ring 34. In further aspects, the hub connector 42 is positioned through the hub bore 44 to secure the first mounting ring 34 to the first retaining ring 40. In still other aspects, a plurality of the hub bore 44 are positioned around the perimeter or circumference of the first mounting ring 34 and the first retaining ring 40, which in some aspects positions the plurality of the hub bore 44 and the plurality of the hub connector 42 between each of the plurality of the cavity 36 in the first mounting ring 34. In still further aspects, the bulb 52 of the tine 38 is flush with the first surface 46 of the first mounting ring 34 such that the first retaining ring 40 engages the bulb 52 when the first mounting ring 34 is connected to the first retaining ring 40. In certain aspects, the hub connector 42 is a nut and bolt combination or a shear pin where the latter is configured to shear or break if a rock or either untillable material is encountered thereby limiting the potential of damaging the strip freshener 10.

In still other aspects, the freshener gang 12 comprises a sleeve 62 that extends between a first end 64 and a second end 66. In some aspects, the first mounting ring 34 is fixedly connected to the sleeve 62 such as by way of welding, monolithic construction, or the like. In some such aspects, the first retaining ring 40 is not fixedly connected to allow for the removal of the first retaining ring 40 from the first mounting ring 34 to permit access to the tine 38 for replacement or modification of the tine 38. In further aspects, a sleeve bore 68 extends through the sleeve 62 and a sleeve connector 70 is passed through the sleeve bore 68 to connect the freshener gang 12 to the frame 14 by way of the sleeve 62. In some aspects, the sleeve bore 68 is positioned adjacent to the first end 64 of the sleeve 62.

In yet other aspects, the freshener gang 12 comprises a second hub 72 comprising one or more of a second mounting ring 74 and a second retaining ring 76 that have aspects similar to those disclosed for the first mounting ring 34 and the first retaining ring 40. In some such aspects, the perimeter or diameter of the second hub 72 is smaller than the perimeter or diameter of the first hub 30. In certain aspects, the tine 38 and cavity 36 of the second mounting ring 74 are the same size and shape as the first hub 30, which allows the tine 38 to be interchangeable between the first hub 30 and second hub 72 thereby reducing the cost of modification or replacement of the tine 38 due to the identical nature of the cavity 36 between the first hub 30 and the second hub 72. In some such aspects, the number tines 38 on the second hub 72 is fewer than the first hub 30, e.g., ten tines 38 on the first hub 30 and eight tines 38 on the second hub 72. In still further aspects, the first hub 30 is positioned closer to the second end 66 of the sleeve 62 than the second hub 72 that is positioned closer to the first end 64 of the sleeve 62. In yet other aspects, the first hub 30 and the second hub 72 are arranged in a back-to-back arrangement such that the first retaining ring 40 and the second retaining ring 76 are positioned outwards towards the first end 64 and the second end 66 of the sleeve 62, respectively. In such a configuration, access to remove the first retaining ring 40 and the second retaining ring 76 is facilitated as a tool 78 (not shown), such as a wrench, does not have to be positioned between the first hub 30 and the second hub 72 to remove either of the first retaining ring 40 or the second retaining ring 76.

In some aspects, the strip freshener 10 comprises a second freshener gang 80 having a third hub 82 and/or a fourth hub 84 connected to a second sleeve 86. In some such aspects, the third hub 82 has aspects similar to those disclosed for the first hub 30, the fourth hub 84 has aspects similar to those disclosed for the second hub 72, and the second sleeve 86 has aspects like those disclosed for the sleeve 62. In some aspects, the third hub 82 having a larger perimeter or diameter than the fourth hub 84 is positioned at the second end 66 of the second sleeve 86 such that the first hub 30 and the third hub 82, having larger perimeters or diameters, are positioned interior to the second hub 72 and the fourth hub 84. In such a configuration, trenching along the side of a strip being tilled is minimized thereby reducing the propensity for erosion and facilitates the reforming of a berm. Additional freshener gangs as well as additional hubs on the freshener gang 12 are contemplated within the scope of the disclosure.

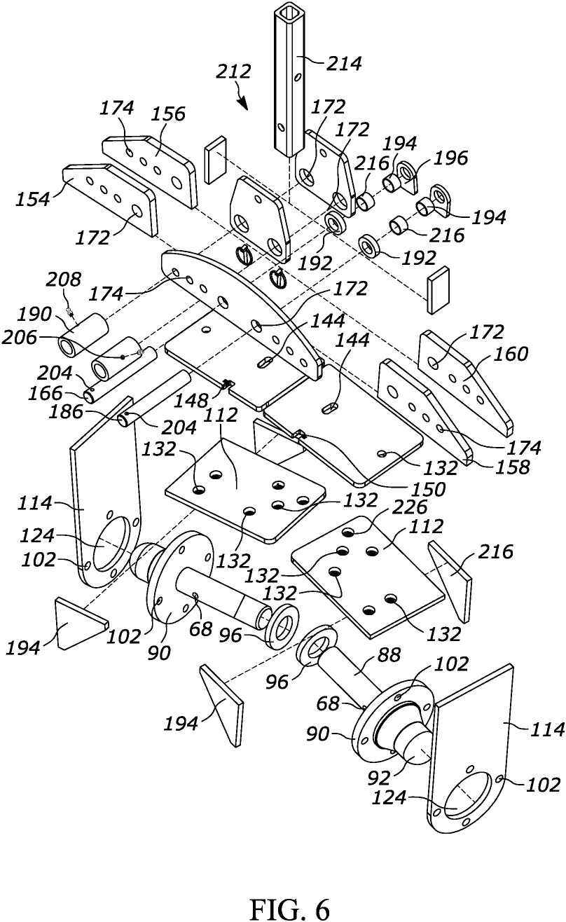

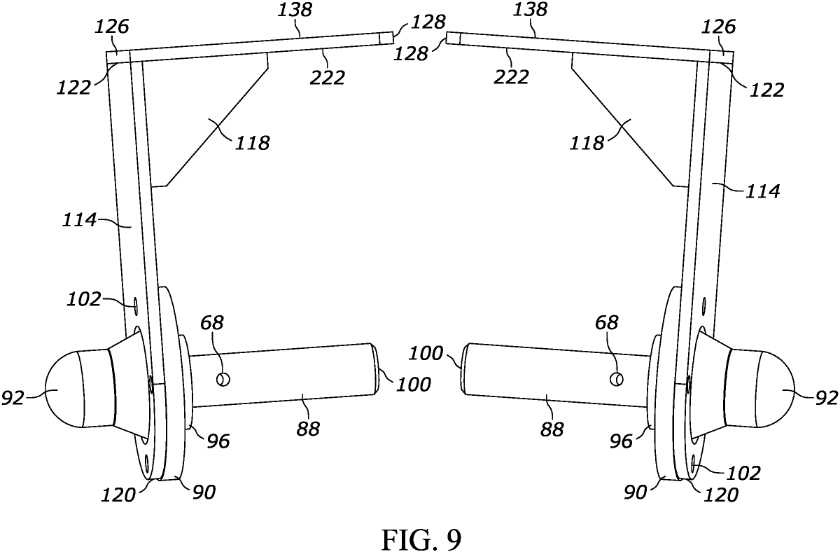

In yet further aspects, and as depicted in at least FIGS. 1-6, and 9, the spindle assembly 16 comprises one or more of a shaft 88, a frame connector plate 90, a cap 92, a bearing 94, and/or a seal guard 96. In some aspects, the shaft 88 extends from a first end 98 to a second end 100. In other aspects, the sleeve bore 68 extends through the shaft 88 such that the sleeve connector 70 passes through the shaft 88 to connect the shaft 88 to the sleeve 62. In still other aspects, when the shaft 88 is connected to the sleeve 62 the second end 100 of the shaft 88 extends to the second end 66 of the sleeve 62 thereby providing rigidity to the length of the sleeve 62.

In other aspects, the frame connector plate 90 extends radially from the first end 98 of the shaft 88. In some aspects, a connector bore 102 extends through the frame connector plate 90 and a spindle connector 104 passes through the connector bore 102 to connect the spindle assembly 16 to the rest of the frame 14. In yet other aspects, a plurality of the connector bore 102 are positioned around the frame connector plate 90 to receive a plurality of the spindle connector 104 to rigidly secure the spindle assembly 16 to the rest of the frame 14.

In further aspects, the cap 92 receives the first end 98 of the shaft 88 that extends through the frame connector plate 90. In still other aspects, the bearing 94 is positioned within the cap 92 and around the shaft 88 to facilitate rotation of the shaft 88 and thereby the freshener gang 12 connected to the shaft 88. In some such configurations, no bearing is present outside of the cap 92 including no bearing present at the second end 100 of the shaft 88. In such a configuration, the absence of a bearing outside of the cap 92 allows the freshener gang 12 to be positioned closer to the second freshener gang 80 thereby allowing for a narrower strip and berm to be formed by the strip freshener 10. In some aspects, the cap 92 contains a second bearing 106 to further facilitate rotation as previously disclosed.

In other aspects, the seal guard 96 abuts the frame connector plate 90 opposite the cap 92. In aspects of the disclosure having the seal guard 96, the seal guard 96 reduces wear on the spindle assembly 16 caused by the sleeve 62.

In further aspects, the frame 14 comprises a second spindle assembly 108 that connects the second freshener gang 80 to the frame 14. In some such aspects, the second spindle assembly 108 has aspects similar to those disclosed with respect to the spindle assembly 16.

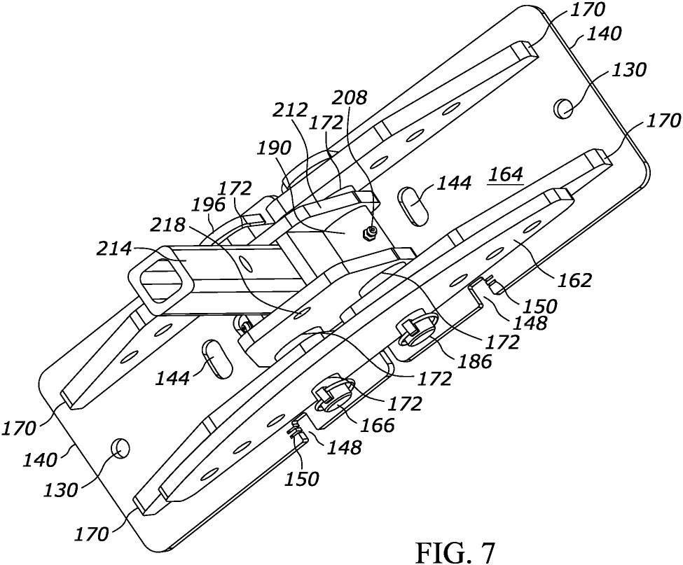

In yet other aspects, and as depicted in at least FIGS. 1-9, the toe angle assembly 18 comprises a bracket 110 and a toe plate 112 that are configured to connect to the spindle assembly 16 and to adjust a toe angle of the freshener gang 12. In further aspects, the bracket 110 comprises one or more of a spindle plate 114, a bracket plate 116, and/or a bracket gusset 118.

In some aspects, the spindle plate 114 extends from a first end 120 to a second end 122 and has a spindle bore 124 that extends through the spindle plate 114 adjacent the first end 120. In some such aspects, the spindle bore 124 is sized and shaped to pass through the cap 92 of the spindle assembly 16 but prevent the frame connector plate 90 from passing through. In other aspects, the connector bore 102 extends through spindle plate 114 adjacent and/or about the first end 120 and the spindle connector 104 is passed through the frame connector plate 90 and the spindle plate 114 to secure the spindle assembly 16 to the toe angle assembly 18. In yet other aspects, the plurality of the connector bore 102 are positioned around the perimeter or circumference of the spindle bore 124 to receive the plurality of the spindle connector 104 to more rigidly secure the spindle assembly 16 to the toe angle assembly 18 while also strengthening the portion of the spindle plate 114 that the spindle bore 124 extends through.

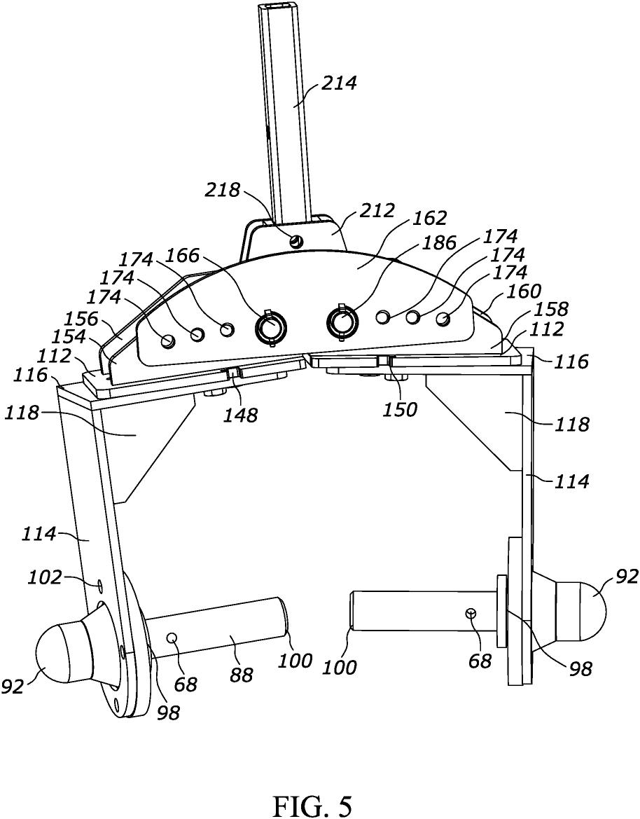

In other aspects, and as depicted in at least FIGS. 5, 8, and 9, the bracket plate 116 connects to and, in some aspects, extends from a first end 126 perpendicularly or substantially perpendicularly from the spindle plate 114 to a second end 128 such that the bracket plate 116 extends in the same direction as and in parallel or substantially parallel relation to the shaft 88 and the sleeve 62. In yet further aspects, the spindle plate 114 and the bracket plate 116 are welded together or formed of a uniform monolithic body.

In further aspects, a toe bore 130, or a plurality of toe bores 130, extend through the bracket plate 116 adjacent the first end 126 of the bracket plate 116. In other aspects, a swivel bore 132, or a plurality of the swivel bore 132, extend through the bracket plate 116 adjacent to the second end 128 of the bracket plate 116. In such a configuration, the toe bore 130 is positioned closer to the first end 126 than the swivel bore 132 and the swivel bore 132 is positioned closer to the second end 128 than the toe bore 130.

In still other aspects, the bracket 110 comprising the bracket gusset 118 extends from a side of the bracket plate 116 adjacent the second end 122 to the bracket plate 116 adjacent the first end 126. In such a configuration the bracket gusset 118 strengthens the frame 14. In yet other aspects, a second bracket gusset 134 extends from the other side of the bracket plate 116 adjacent the second end 122 to the bracket plate 116 adjacent the first end 126 to further strengthen the frame 14.

In yet further aspects, the toe bore 130 extends through the toe plate 112 and a toe connector 136 passes through the toe bore 130 to connect the toe plate 112 above the bracket plate 116 such that the toe plate 112 engages a top surface 138 of the bracket plate 116. In some aspects, the toe bore 130 is adjacent a first end 140 of the toe plate 112 and adjacent a second end 142 of the toe plate 112 is a swivel slot 144 that in certain aspects forms an elongated opening. In still other aspects, a swivel connector 146 is received through the swivel slot 144 of the toe plate 112 and the swivel bore 132 of the bracket plate 116.

In such configurations, the toe connector 136 acts as a pivot point about which the toe plate 112 and the bracket plate 116 can rotate about each other to adjust the toe angle of the freshener gang 12. When the desired toe angle is reached, the swivel connector 146 is passed through the swivel slot 144 and the corresponding of the swivel bore 132 to fix the position and relationship between the toe plate 112 and the bracket plate 116. The presence of the plurality of the toe bore 130 and the swivel bore 132 allows for various fixed toe angles to be chosen from. Similarly, the form of the swivel slot 144 provides for fine tuning of the desired toe angle and thereby the level of the berm to be formed during tilling.

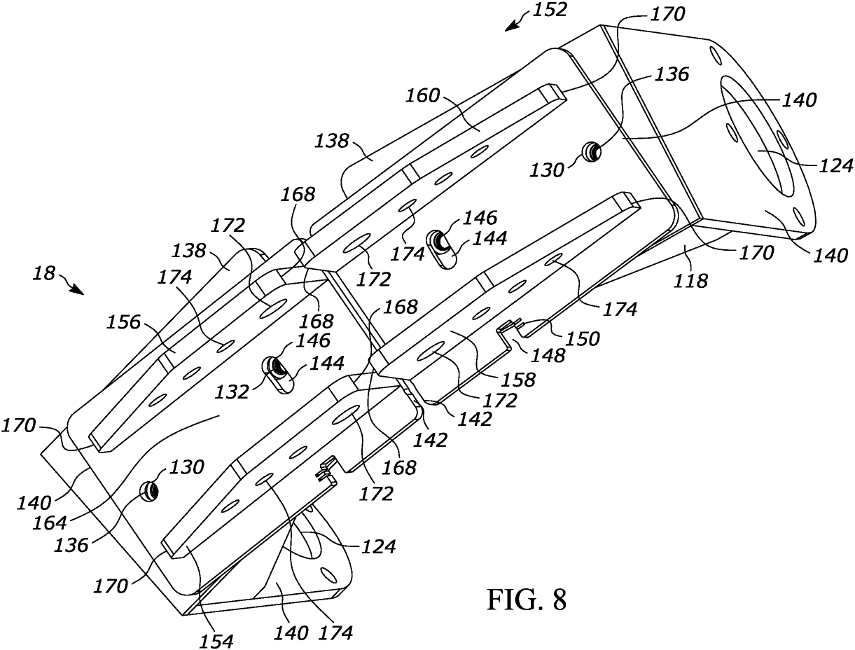

In some aspects, the toe plate 112 has a toe window 148 positioned through the toe plate 112 between the toe bore 130 and the swivel slot 144. As seen in the exemplary depiction of FIG. 8, the position of the toe plate 112 above the bracket plate 116 allows an edge of the bracket plate 116 to be seen from above as the bracket plate 116 is positioned in relation to the toe plate 112, which allows the relative angle between the two to be viewed by an individual. In further aspects, an indicia 150 is set next to the toe window 148 and indicates predefined toe angles such that when the edge of the bracket plate 116 extends to the indicia 150 the predefined toe angle is achieved, e.g., a 4° toe angle. In this way, the indicia 150 provides for rapid resetting of the desired toe angel should replacement of one of the tines 38 take place.

In some aspects, the frame 14 comprises a second toe angle assembly 152 that connects the second spindle assembly 108 to the frame 14. In some such aspects, the second toe angle assembly 152 has aspects like those disclosed with respect to the toe angle assembly 18. In yet other aspects, the toe plate 112 of the toe angle assembly 18 and second toe angle assembly 152 are a single component such that the pair of the toe plate 112 are formed in a single plate without any separation therebetween.

In yet further aspects still, the camber assembly 20 comprises a vertical plate 154, a second vertical plate 156, a third vertical plate 158, a fourth vertical plate 160, a camber plate 162, and/or a camber rod assembly 166. With reference to at least FIGS. 1-7, the vertical plate 154 and/or the second vertical plate 156 extends from a top surface 164 of the toe plate 112 of the toe angle assembly 18. In some such aspects, the vertical plate 154 and/or the second vertical plate 156 are fixedly connected to the toe plate 112 by welding or monolithic construction. In aspects having the second toe angle assembly 152, the third vertical plate 158 and/or fourth vertical plate 160 extend from the top surface 164 of the toe plate 112 of the second toe angle assembly 152. In some such aspects, the third vertical plate 158 and/or the fourth vertical plate 160 are fixedly connected to the toe plate 112 by welding or monolithic construction.

In further aspects, the vertical plate 154, the second vertical plate 156, the third vertical plate 158, and the fourth vertical plate 160 have similar or identical structures which are understood by the disclosure related to the vertical plate 154.

The vertical plate 154 extends between an interior end 168 to an exterior end 170. In some aspects, a camber bore 172 extends through the vertical plate 154 adjacent the interior end 168. In other aspects, one or more of an offset bore 174 extends through the vertical plate 154 adjacent the exterior end. In certain aspects, a plurality of offset bores 174 are positioned through the vertical plate 154 at offset vertical locations along a length extending from the exterior end 170 to the camber bore 172.

In aspects having the second vertical plate 156, the camber bore 172 and the offset bore 174 of the second vertical plate 156 are in alignment with the vertical plate 154. Likewise, where the third vertical plate 158 and the fourth vertical plate 160 are present, the camber bore 172 and the offset bore 174 align, respectively.

In further aspects, the camber bore 172 and the offset bore 174 extend through the camber plate 162 in alignment with the vertical plate 154 and the second vertical plate 156 such that the camber bore 172 is in an interior position 176 in relation to the offset bore 174 positioned between the camber bore 172 and a first exterior end 178 of the camber plate 162.

In aspects having the third vertical plate 158 and the fourth vertical plate 160, a second of the camber bore 172 is positioned through a second interior position 180 of the camber plate 162 in relation to the offset bore 174 positioned between the second interior position 180 and a second exterior end 182 of the camber plate 162. In this configuration, the second of the camber bore 172 and the offset bore 174 align with the camber bore 172 and offset bore 174 of the third vertical plate 158 and the fourth vertical plate 160.

In other aspects, a camber rod assembly 166 is received through the camber plate 162 and the vertical plate 154 and/or second vertical plate 156. In some such aspects, the second exterior end 182 is a pivot point about which the vertical plate 154 and/or second vertical plate 156 rotate in relation to the camber plate 162. In this configuration, the camber of the freshener gang 12 is adjustable. When the desired camber is reached, an offset connector 184 is passed through the respective of the offset bore 174 of the vertical plate 154 and/or second vertical plate 156 and the camber plate 162 to fix the camber of the freshener gang 12. In aspects having the second freshener gang 80, a similar structure is present whereby a second camber rod assembly 186 is passed through the camber plate 162 via the camber bore 172 in the second interior position 180 and the camber bore 172 of the third vertical plate 158 and the fourth vertical plate 160.

The camber rod assembly 166, in some aspects, comprises a camber rod 188, a spacer 190, a camber bearing 192, one or more of a gasket 194, a stop 196, and/or a rod lock or pin 198. In further aspects, the camber rod 188 extends from a first end 200 to a second end 202 with the stop 196 fixedly positioned at the second end 202 and a lock bore 204 extending through the camber rod 188 adjacent the first end 200 through which the rod pin 198 is received. In other aspects, the spacer 190 is positioned around the camber rod 188 between the first end 200 and the second end 202.

In certain aspects, the spacer 190 is sized and shaped to fit along a length of the camber rod 188 between the vertical plate 154, the second vertical plate 156, and/or the stem assembly as further disclosed herein. Positioned on the camber rod 188 and between the camber rod 188 and the spacer 190 is the camber bearing 192 and the gasket 194. The camber bearing 192, in some aspects, is configured to facilitate the rotation of the camber rod 188.

In still other aspects, the spacer 190 has a set bore 206 that receives a set screw 208 to fix the relation between the spacer 190 and the camber bearing 192. The spacer 190, in some aspects, limits vibration to the camber assembly 20.

In yet further aspects, the rod pin 198 is a shear pin and prevents rotation of the camber rod 188. In such configurations, the rod pin 198 will shear or break if an untillable material is encountered thereby limiting the chance that the strip freshener 10 will be damaged.

In aspects where the third vertical plate 158 and/or the fourth vertical plate 160 are present the second camber rod assembly 186 sets and fixes the camber of the second freshener gang 80. In some such aspects, the second camber rod assembly 186 has aspects similar to those disclosed for the camber rod assembly 166.

In other aspects, depicted in at least FIGS. 1-4, the stem assembly 24 comprises a stem housing 212 and a stem 214. In further aspects, the camber bore 172 extends through the stem housing 212 and the camber rod 188 is received therethrough. In some such aspects, the spacer 190 is sized and shaped to fit within the stem housing 212 with the gasket 194 positioned between the stem housing 212 and the vertical plate 154 and a second gasket 216 positioned between the stem housing 212 and the second vertical plate 156.

In further aspects, the stem 214 extends through and above the stem housing 212 to connect to the tool bar 26. A stem bore 218 extends through the stem housing 212 and stem 214 and receives a stem connector 220, such as a nut and bolt combination, to secure the stem housing 212 to the stem 214.

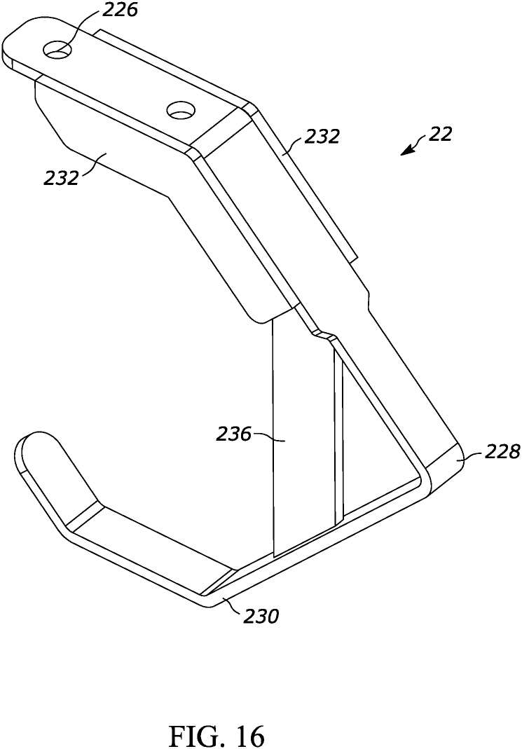

In some aspects, and as depicted in at least FIGS. 1-4, and 16, the scraper 22 is mounted to a bottom surface 222 of the bracket plate 116 with a scraper connector 224 positioned through a scraper bore 226 that extends through the scraper 22 and the bracket plate 116. In other aspects, the scraper 22 extends downwardly and rearwardly from the bracket plate 116 to a transition point 228 whereupon the scraper 22 extends downwardly and inwardly to a second transition point 230 below the sleeve 62 of the freshener gang 12 and thereupon extends upwardly and forwardly such that the scraper 22 is positioned partially around the sleeve 62. In still other aspects, the scraper 22 is positioned between the first hub 30 and the second hub 72. In yet further aspects, a scraper gusset 232 is attached to the scraper 22 abutting the bracket plate 116 to provide additional strength and rigidity, which is further enhanced by having a plurality of the scraper gusset 232 fixed to the scraper 22. In aspects having the second freshener gang 80, a second scraper 234 having a like structure as that disclosed is positioned between the third hub 82 and the fourth hub 84. In other aspects, a bracer 236 extends between the scraper 22 offset from the transition point 228 to reinforce the scraper 22.

In addition to exemplary operations have been discussed with respect to the strip freshener 10, including adjustment of toe angle and camber, in another exemplary operation the strip freshener 10 further simplifies replacement of the tine 38. An individual first removes the swivel connector 146 from the swivel bore 132 of the bracket plate 116 and the swivel slot 144 the toe plate 112. In doing so, the bracket 110 is freed to rotated about the toe connector 136 such that the freshener gang 12 is rotated away from the rest of the toe angle assembly 18 and camber assembly 20. Next, the sleeve connector 70 is removed such that the sleeve 62 is separable from the shaft 88 of the spindle assembly 16. In this way, the freshener gang 12 is removable entirely from the rest of the strip freshener 10. The outward facing of the first retaining ring 40 of the first hub 30 and the second retaining ring 76 of the second hub 72 provides unfettered removal of each by removing the respective of the hub connector 42. Once removed any of the tine 38 that require replacement or medication are removed from the respective of the cavity 36 and modified or replaced. The process is then reversed to return the strip freshener 10 to the original state.

Therefore, a strip freshener 10 has been provided that improves strip tilling, limits the occurrence of clods and voids in a reformed berm, forms a berm of friable soil, is adjustable with respect to till depth and strip closing, avoids component breakage, is easily repairable and/or replaceable, decreases downtime, is cost-effective, is user friendly, and improves upon the art.

From the above discussion and accompanying figures and claims it will be appreciated that the strip freshener 10 offers many advantages over the prior art. Although the present disclosure and its advantages have been described in detail, it should be understood that various changes, substitutions, modifications, and alterations can be made herein without departing from the technology of the disclosure as defined by the appended claims. The scope of the present application is not intended to be limited to the particular configurations of the process, machine, manufacture, composition of matter, means, methods and steps described in the specification only expressly stated otherwise. As one of ordinary skill in the art will readily appreciate from the disclosure, processes, machines, manufacture, compositions of matter, means, methods, or steps, presently existing or later to be developed that perform substantially the same function or achieve substantially the same result as the corresponding configurations described herein may be utilized according to the present disclosure. Accordingly, the appended claims are intended to include within their scope such processes, machines, manufacture, compositions of matter, means, methods, or steps.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A strip freshener comprising:
a tine having a retention portion and a tooth;
a mounting member having a cavity in a first surface of the mounting member;
the retention portion of the tine received in the cavity;
a retaining member removably connected to the mounting member; and
wherein the cavity is shaped like the retention portion;
wherein the retention portion is positioned between the retaining member and a second surface of the mounting member.

2. The strip freshener of claim 1 wherein the retention portion has a circular base and a rectangular portion, and the rectangular portion is positioned between the circular base and the tooth.

3. The strip freshener of claim 1 wherein the retention portion is flush with the first surface of the mounting member such that the retaining member engages the retention portion.

4. The strip freshener of claim 1 wherein the tooth tapers from the retention portion in a helix shape.

5. The strip freshener of claim 1 further comprising a sleeve that extends from a first end to a second end, and the mounting member is fixedly connected to the sleeve.

6. The strip freshener of claim 1 further comprising a second tine received in a second mounting member; a second retaining member removably connected to the second mounting member; wherein the second mounting member is smaller than the mounting member.

7. The strip freshener of claim 6 further comprising the second mounting member having a second cavity, wherein the second cavity is sized and shaped to match the cavity of the mounting member.

8. The strip freshener of claim 6 further comprising a sleeve that extends from a first end and a second end; the mounting member and the second mounting member arranged in a back-to-back arrangement such that the retaining member and the second retaining member are positioned outwards towards the first end and the second end of the sleeve.

9. The strip freshener of claim 5 further comprising a spindle assembly having a shaft that extends from a first end to a second end, a frame connector, a cap, and a bearing; the bearing contained inside the cap and around the shaft; the cap connected to the first end of the shaft; the shaft received within and connected to the sleeve; and the frame connector connected to a frame; wherein no other no bearing is positioned outside of the cap.

10. The strip freshener of claim 9 wherein the second end of the shaft extends to the second end of the sleeve.

11. The strip freshener of claim 5 further comprising the sleeve connected to a bracket of a toe angle assembly; the toe angle assembly having a toe plate pivotally connected to a bracket plate of the bracket; wherein the toe angle assembly is configured to adjust a toe angle of the tine and the mounting member in relation to the toe plate.

12. The strip freshener of claim 11 further comprising the toe plate having a swivel slot that aligns with a swivel bore of the bracket plate.

13. The strip freshener of claim 11 further comprising the toe plate having a toe window configured to show a position of the bracket plate relative to the toe plate; and an indicia set next to the toe window; wherein the indicia represents at least one predefined toe angle when the bracket plate aligns with the indicia.

14. The strip freshener of claim 5 further comprising the sleeve pivotally connected to a camber plate of a camber assembly; wherein the camber assembly is configured to adjust a camber of the tine and the mounting member.

15. The strip freshener of claim 14 further comprising the camber assembly comprising a vertical plate connected to a toe plate; the toe plate connected to the sleeve; and the vertical plate pivotally connected to the camber plate by a camber rod assembly received through a camber bore.

16. The strip freshener of claim 15 further comprising the vertical plate and the camber plate having an offset bore; an offset connector received through the offset bore.

17. The strip freshener of claim 15 further comprising the camber rod assembly having a camber rod and a rod pin; wherein the rod pin fixes the camber.

18. The strip freshener of claim 17 wherein the rod pin is configured to shear.

19. The strip freshener of claim 5 further comprising the sleeve connected to a stem assembly having a stem; and the sleeve connected to a scraper configured to remove debris from the tine.

20. A strip freshener comprising:
a tine having a retention portion and a tooth;
a mounting member having a cavity in a first surface of the mounting member, wherein the cavity is shaped like the retention portion;
the retention portion of the tine received in the cavity;
a retaining member removably connected to the mounting member, wherein the retention portion is positioned between the retaining member and a second surface of the mounting member;
a sleeve fixedly connected to the mounting member;
the sleeve connected to a frame;
the frame having a spindle assembly; wherein the spindle assembly is configured to rotate the sleeve;
the frame having a toe angle assembly, wherein the toe angle assembly is configured to adjust a toe angle of the sleeve relative to the frame; and
the frame having a camber assembly, wherein the camber assembly is configured to adjust a camber of the sleeve relative to the frame.
